(19) United States
(12) Patent Application Publication
(10) Pub. No.: US 2026/0319847 A1
(43) Pub. Date: Oct. 15, 2026

(54) INTELLIGENT BATCH PROCESSING AND JOB SCHEDULING

(71) Applicant: International Business Machines Corporation, Armonk, NY (US)

(72) Inventors: NITIN TEWARI, GHAZIABAD (IN); Renjith Ramakrishnan, Kollam (IN); PADMA LOCHANA MOHAPATRA, NEW DELHI (IN); Rashmi Gupta, NOIDA (IN)

(21) Appl. No.: 19/176,971

(22) Filed: Apr. 11, 2025

(51) Int. Cl. G06F 9/50

(52) U.S. Cl. CPC G06F 9/5027

(57) ABSTRACT

Systems and techniques that facilitate quantum feature map generation are provided. For example, one or more embodiments described herein can comprise a system, which can comprise a memory that can store computer executable components. The system can also comprise a processor, operably coupled to the memory that can execute the computer executable components stored in memory. The computer executable components can comprise a collection component that collects planned job schedules, job dependencies, historical job flow path recommendations, and historical batch processing statistics for one or more job types in a queue from system management facility logs; and a flow path component that determines, using a machine learning model, one or more possible job flow paths for the queue of jobs based on the planned job schedules, job dependencies, historical job flow path recommendations, and historical batch processing statistics for one or more job types in the queue.

### BACKGROUND

The subject disclosure relates to batch processing and job scheduling, and more specifically to intelligent batch processing and job scheduling with real-time inputs.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate intelligent batch processing and job scheduling are provided.

According to an embodiment, a system can comprise: a memory that stores computer executable components; and a processor that executes the computer executable components stored in the memory, wherein the computer executable components comprise: a collection component that collects planned job schedules, job dependencies, historical job flow path recommendations, and historical batch processing statistics for one or more job types in a queue from system management facility logs; and a flow path component that determines, using a machine learning model, one or more possible job flow paths for the queue of jobs based on the planned job schedules, job dependencies, historical job flow path recommendations, and historical batch processing statistics for one or more job types in the queue.

According to another embodiment, a computer-implemented method can comprise collecting, by a device operatively coupled to a processor, planned job schedules, job dependencies, historical job flow path recommendations, and historical batch processing statistics for one or more job types in a queue from system management facility logs; and generating, by the device, using a machine learning model, one or more possible job flow paths for the queue of jobs based on the planned job schedules, job dependencies, historical job flow path recommendations, and historical batch processing statistics for one or more job types in the queue.

According to another embodiment, a computer program product can comprise a computer readable storage medium having program instructions embodied therewith, the program instructions executable by a processor to cause the processor to collect, by the processor, planned job schedules, job dependencies, historical job flow path recommendations, and historical batch processing statistics for one or more job types in a queue from system management facility logs; and generating, by the processor, using a machine learning model, one or more possible job flow paths for the queue of jobs based on the planned job schedules, job dependencies, historical job flow path recommendations, and historical batch processing statistics for one or more job types in the queue.

### DESCRIPTION OF THE DRAWINGS

FIGS. 1 and 2 illustrate block diagrams of example, non-limiting, systems that can facilitate intelligent batch processing in accordance with one or more embodiments described herein.

FIG. 3 illustrates a use case of additional jobs being added to an existing schedule in accordance with one or more embodiments that have been described herein.

FIG. 4 illustrates a dynamic flow use case in accordance with one or more embodiments described herein.

FIG. 5 illustrates a changing data pattern use case in accordance with one or more embodiments described herein.

FIG. 6 illustrates a flow diagram of intelligent batch processing in accordance with one or more embodiments described herein.

FIG. 7 illustrates an alternative flow diagram of intelligent batch processing in accordance with one or more embodiments described herein.

FIG. 8 illustrates a graph showing factors that are weighed as part of a recommendation process in accordance with one or more embodiments described herein.

FIG. 9 illustrates a flow diagram of an example, non-limiting, computer-implemented method that facilitates intelligent batch processing in accordance with one or more embodiments described herein.

FIG. 10 illustrates an example, non-limiting environment for the execution of at least some of the computer code in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

As referenced herein, an “entity” can comprise a client, a user, a computing device, a software application, an agent, a machine learning (ML) model, an artificial intelligence (AI) model, and/or another entity.

Batch processing is a critical component of modern Information Technologies. During batch processing, a queue of jobs is scheduled for execution, with the various jobs being assigned execution times and specific hardware or virtual hardware for execution. However, as computing tasks continue to become more complex, the complexity of the job scheduling also increases due to factors such as number of jobs, computing resources need to execute the jobs, time or execution dependencies between jobs, and scheduling constraints, such as service level agreements. Without optimization, job schedules can cause increasing technical debt, increased operational costs (both in the workload of computer components and the power consumption required) and sustainability concerns. Additionally, due to the complexity and number of jobs, if or when an execution failure does occur, it can be difficult to correctly re-arrange the job schedule to minimize disruption and extra workload for the processing components.

In view of the problems discussed above, the present disclosure can be implemented to produce a solution to one or more of these problems by collecting planned job schedules, job dependencies, historical job schedules, historical recommended job schedules and historical batch processing statistics from system management facility logs for one or more job types in a job queue, and determine, using a machine learning model, one or more possible job flow paths (e.g., possible schedules) based on the planned job schedules, job dependencies, historical job flow path recommendations, and historical batch processing statistics for one or more job types in the queue. The one or more possible job flow paths can comprise order and timing for the execution of the jobs in the queue, as well as designations for specific hardware the jobs will be executed on. The one or more possible job flow paths can additionally be accompanied by predicted runtime statistics such as hardware execution costs, power consumption, and total required runtime.

In various embodiments, the solution to the above described problems can further comprise recommending one or more job flow paths from the one or more possible job flow paths based on scheduling obligations and execution cost metrics of the one or more possible job flow paths. These recommendations can assist an entity, such as a user, in selecting one of the recommended job flow paths for execution that optimizes both the execution costs as well as scheduling obligations, such service level agreements (SLA).

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

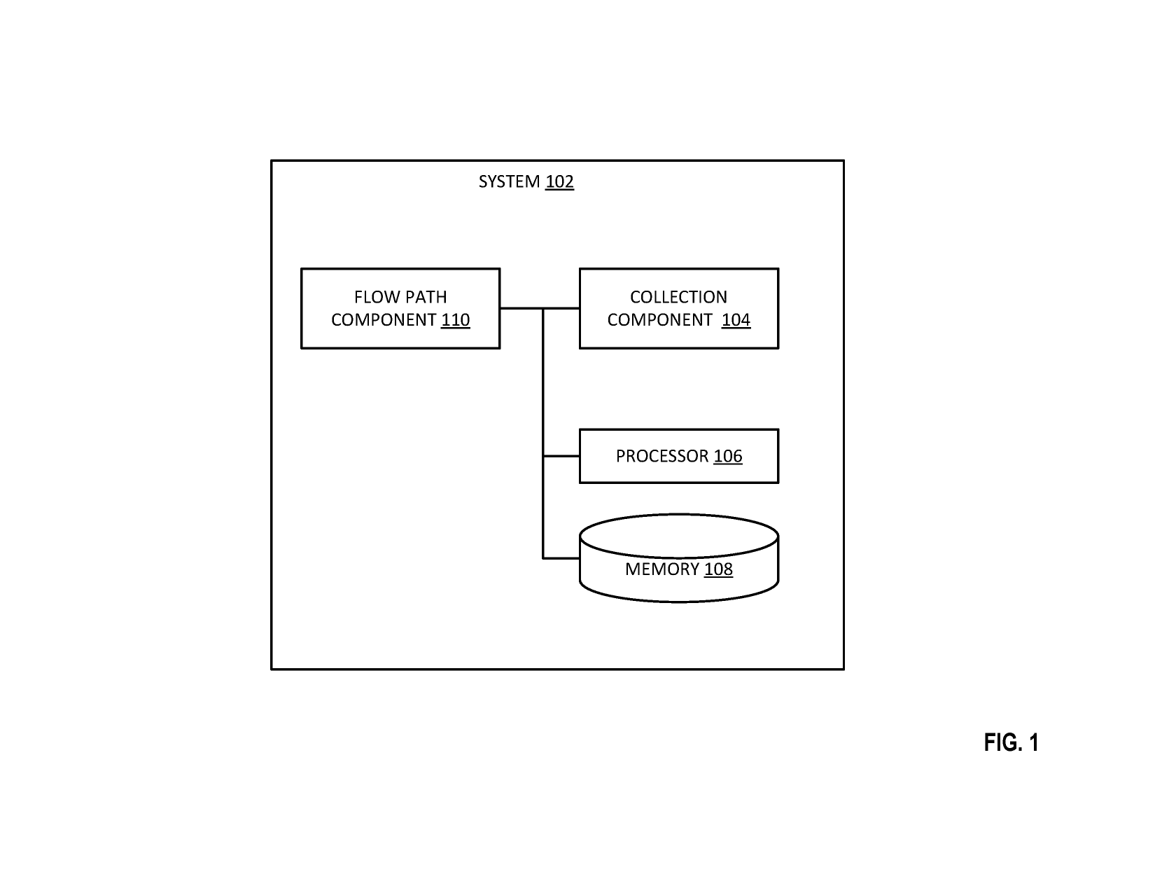

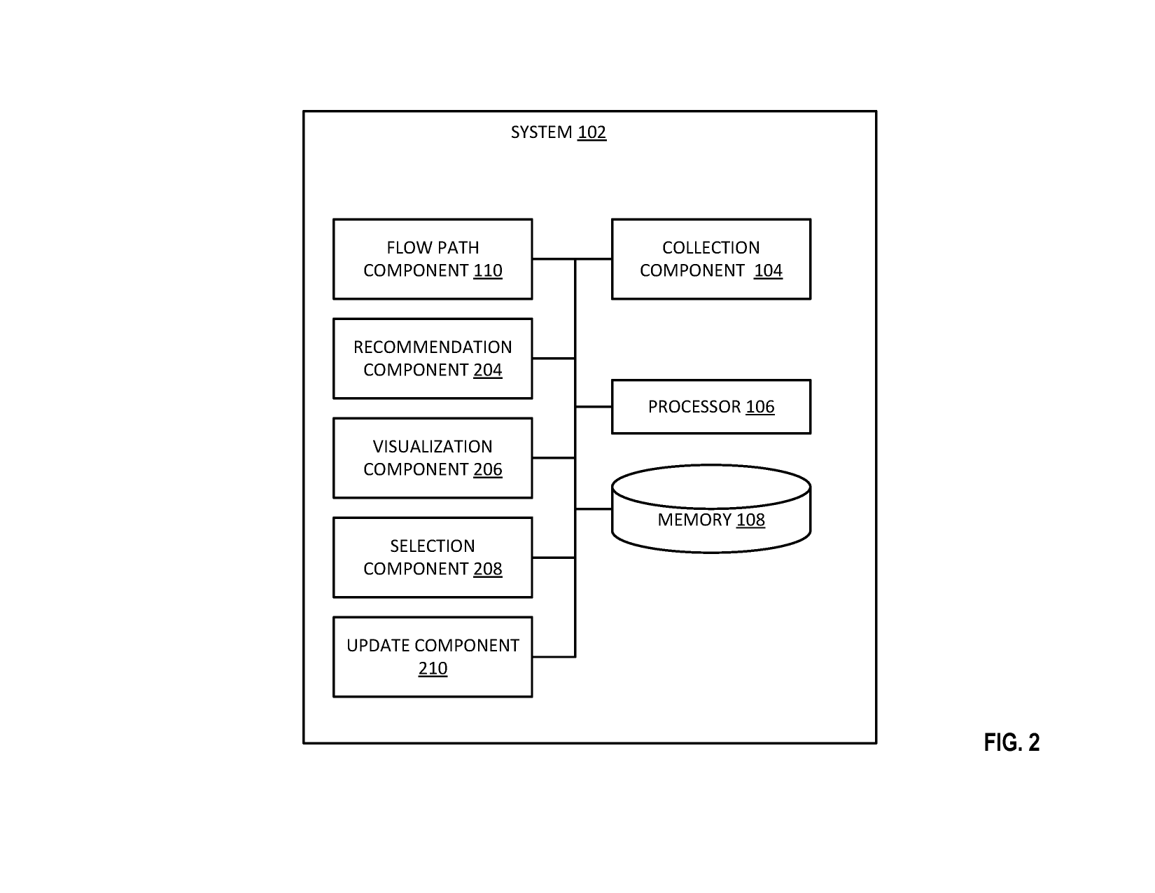

FIGS. 1 and 2 illustrate block diagrams of example, non-limiting systems 102 and 202 that can facilitate intelligent batch processing in accordance with one or more embodiments described herein. Aspects of systems (e.g., systems 102, 202 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines (e.g., computers, computing devices, virtual machines, etc.), can cause the machines to perform the operations described. System 102 can comprise flow path component 110, collection component 104, processor 106 and memory 108. System 202 can further comprise recommendation component 204, visualization component 206, selection component 208 and update component 210.

In various embodiments, systems 102 and 202 can comprise a processor 106 (e.g., a computer processing unit, microprocessor) and a computer-readable memory 108 that is operably connected to the processor 106. The memory 108 can store computer-executable instructions which, upon execution by the processor, can cause the processor 106 and/or other components of the systems 102 and 202 (e.g., flow path component 110, collection component 104, recommendation component 204, visualization component 206, selection component 208 and update component 210) to perform one or more acts. In various embodiments, memory 108 can store computer-executable components (e.g., flow path component 110, collection component 104, recommendation component 204, visualization component 206, selection component 208 and update component 210) and processor 106 can execute the computer-executable components.

According to some embodiments, flow path component 110 and/or recommendation component 204 can employ automated learning and reasoning procedures (e.g., the use of explicitly and/or implicitly trained statistical classifiers) in connection with performing inference and/or probabilistic determinations and/or statistical-based determinations in accordance with one or more aspects described herein.

For example, flow path component 110 and/or recommendation component 204 can employ principles of probabilistic and decision theoretical inference to determine one or more responses based on information retained in a knowledge source database. Additionally, or alternatively, flow path component 110 and/or recommendation component 204 can rely on predictive models constructed using machine learning and/or automated learning procedures. Logic-centric inference can also be employed separately or in conjunction with probabilistic methods. For example, decision tree learning can be utilized to map observations about data retained in a knowledge source database to derive a conclusion as to a response to a question.

As used herein, the term “inference” refers generally to the process of reasoning about or inferring states of the system, a component, a module, the environment, and/or assessments from one or more observations captured through events, reports, data, and/or through other forms of communication. Inferences can be employed to identify a specific context or action, or can generate a probability distribution over states, for example. The inference can be probabilistic. For example, computation of a probability distribution over states of interest can be based on consideration of data and/or events. The inference can also refer to techniques employed for composing higher-level events from one or more events and/or data. Such inference can result in the construction of new events and/or actions from one or more observed events and/or stored event data, whether or not the events are correlated in close temporal proximity, and whether the events and/or data come from one or several events and/or data sources. Various classification schemes and/or systems (e.g., support vector machines, neural networks, logic-centric production systems, Bayesian belief networks, fuzzy logic, data fusion engines, and so on) can be employed in connection with performing automatic and/or inferred action in connection with the disclosed aspects. Furthermore, the inference processes can be based on stochastic or deterministic methods, such as random sampling, Monte Carlo Tree Search, and so on.

The various aspects can employ various artificial intelligence-based schemes for carrying out various aspects thereof. For example, generating and recommending job flow paths which can be enabled through an automatic classifier system and process.

A classifier is a function that maps an input attribute vector, x = (x1, x2, x3, x4, xn), to a confidence that the input belongs to a class. In other words, f(x) = confidence(class). Such classification can employ a probabilistic and/or statistical-based analysis (e.g., factoring into the analysis utilities and costs) to prognose or infer an action that should be employed to make a determination. The determination can include, but is not limited to, the generation of possible job flow paths, recommendations on the possible job flow paths, and the like.

A support vector machine (SVM) is an example of a classifier that can be employed. The SVM operates by finding a hypersurface in the space of possible inputs, which attempts to split the triggering criteria from the non-triggering events. Intuitively, this makes the classification correct for testing data that can be similar, but not necessarily identical to training data. Other directed and undirected model classification approaches (e.g., naïve Bayes, Bayesian networks, decision trees, neural networks, fuzzy logic models, and probabilistic classification models) providing different patterns of independence can be employed. Classification as used herein, can be inclusive of statistical regression that is utilized to develop models of priority.

One or more aspects can employ classifiers that are explicitly trained (e.g., through a generic training data) as well as classifiers that are implicitly trained (e.g., by observing and recording target entity behavior, by receiving extrinsic information, and so on). For example, SVM’s can be configured through a learning phase or a training phase within a classifier constructor and feature selection module. Thus, a classifier(s) can be used to automatically learn and perform a number of functions, including but not limited to, the generation of possible job flow paths, recommendations on the possible job flow paths, and the like. Furthermore, one or more aspects can employ machine learning models that are trained utilizing reinforcement learning. For example, penalty/reward scores can be assigned for various outputs generated by flow path component 110 and/or recommendation component 204 based on defined entity preferences. Accordingly, flow path component 110 and recommendation component 204 can learn via selecting options with lower penalties and/or higher rewards in order to reduce an overall penalty score and/or increase an overall reward score.

In one or more embodiments, collection component 104 can collect planned job schedules, job dependencies, historical flow path recommendations, and historical batch processing statistic from one or more job types in a queue from system management facility logs. For example, collection component 104 can collect historical data such as previously executed job schedules, the execution costs of the previously executed job schedules, and the reliability of the previously executed job schedules. Historical batch processing statistics such as processing volume, CPU time and elapsed time can also be collected. In one or more embodiments, collection component 104 can collect constraint data such as scheduling time constraints, operational cost, subsystem resources or other constraints. In one or more embodiments, collection component 104 can further collect live data such as a currently executing job schedule, the status of the currently executing job schedule, live metadata from the computing resources, time delay, and future resource availability.

In one or more embodiments, flow path component 110 can determine, using a machine learning model, one or more possible flow paths for the queue of jobs based on the planned job schedules, job dependencies, historical job flow path recommendations, and historical batch processing statistics for one or more job types in the queue. As used herein a “flow path”, alternatively referred to as a schedule, can comprise an order and timing for execution of one or more computing jobs as well as designations for what hardware components will execute which jobs. For example, the information collected by collection component 104 can be fed as input to flow path component 110. In one or more embodiments, flow path component 110 can comprise one or more machine learning models that generate all possible job flow paths that meet the constraints and job dependencies collected by collection component 104. For example, given a job queue, scheduling constraints for the job queue, a currently executing job schedule and resource availability, flow path component 110 can generate one or more possible flow paths that would allow for execution of the queue of jobs within the time and resource constraints.

Continuing to FIG. 2, in one or more embodiments, recommendation component 204 can recommend one or more job flow paths from the one or more possible job flow paths based on scheduling obligations and execution cost metrics of the one or more possible job flow paths. For example, recommendation component 204 can receive a list of the possible job flow paths from flow path component 110. Recommendation component 204 can then rank the possible job flow paths based on one or more criteria, such as execution cost, scheduling obligations total execution time, or other recommendation criteria as specified by an entity, such as a user. In a further embodiment, recommendation component 204 can utilize the machine learning model of flow path component 110 or comprise its own machine learning model for making recommendations. For example, using the machine learning model, recommendation component 204 can look at historical recommended job flow paths for the entity and/or executed job flow paths selected by the entity to identify possible preferences or trends. These preferences or trends can then be utilized as additional criteria for ranking the possible job flow paths. Once the possible job flow paths are ranked, recommendation component 204 can recommend the top x number of possible flow paths to the entity, wherein x is an integer. Accordingly, recommendation component 204 can provide one or more recommended job flow paths to an entity for selection.

In one or more embodiments, recommendation component 204 can further recommend one or more of the possible job flow paths based on sustainability metrics, wherein the sustainability metrics comprise type of electrical generation source for an execution environment and availability of electrical power from specific sources at one or more times. For example, recommendation component 204 can prioritize assigning jobs to hardware powered by renewable energy sources, and/or schedule jobs for times that renewable energy is available.

In one or more embodiments, visualization component 206 can generate a graphical representation of the one or more possible job flow paths and one or more execution metrics of the possible job flow paths. For example, visualization component 206 can generate a visual flow chart showing the order of execution of jobs within the flow path on a user interface, such as a monitor. The flow chart can further show additional details, such as the time each job would be expected to start and end, the expected execution of each job, the total execution cost, whether scheduling constraints are met, or other information related to the flow path. This can be performed for each possible flow path, allowing an entity to better view the flow path and associated execution costs.

In one or more embodiments, selection component 208 can select a job flow path from the one or more recommend job flow paths and execute the selected job flow path. For example, in an embodiment, selection component 208 can select the highest ranked of the recommended job flow paths. In another example, selection component 208 can select a job flow path based on input from an entity such as a user. In a further example, if one of the recommended job flow paths matches a historical job flow path that has been selected previously, selection component 208 can select the matching job flow path. Once a job flow path is selected, selection component 208 can send execution instructions and timing to assigned hardware components for execution of the job flow path and execute the job flow path at the assigned starting time.

In one or more embodiments, update component 210 can update the machine learning models of flow path component 110 and/or recommendation component 204 based on at least one of the selected job flow path and one or more rejected job flow paths. For example, update component 210 can finetune recommendation component 204 with rewards scores based on selected job flow paths from the list of recommendations or penalty scores for recommending job flow paths that were rejected. In this manner, recommendation component 204 can learn to make better recommendations to the entity and/or selection component. In another example, update component 210 can update flow path component 110 based on a comparison of the actual execution costs of the selected job flow path and the predicted execution costs predicted by the flow path component. For example, if the actual execution costs and predicted execution costs were within a defined difference amount of one and other, then a reward score can be assigned for accurate predictions. If the difference is greater than the defined amount, then a penalty score can be assigned to help flow path component 110 make better predictions in the future.

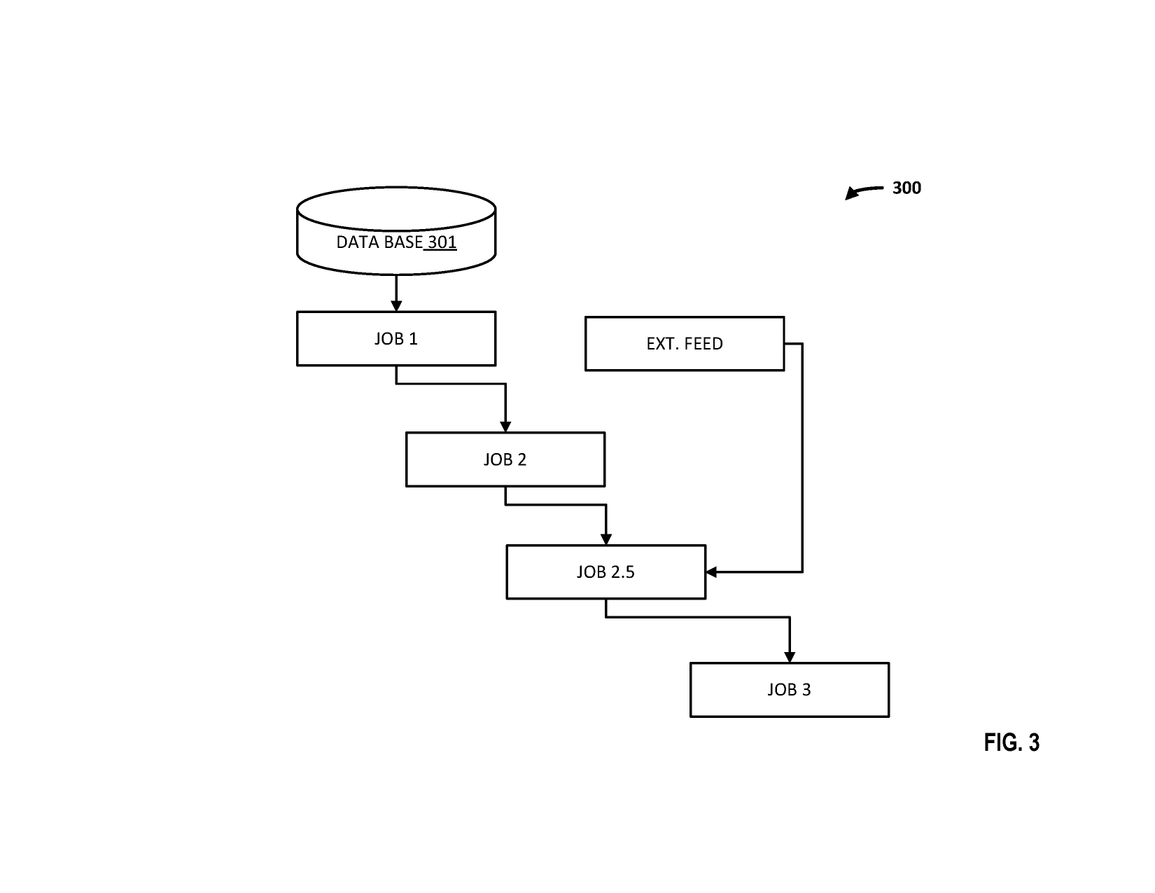

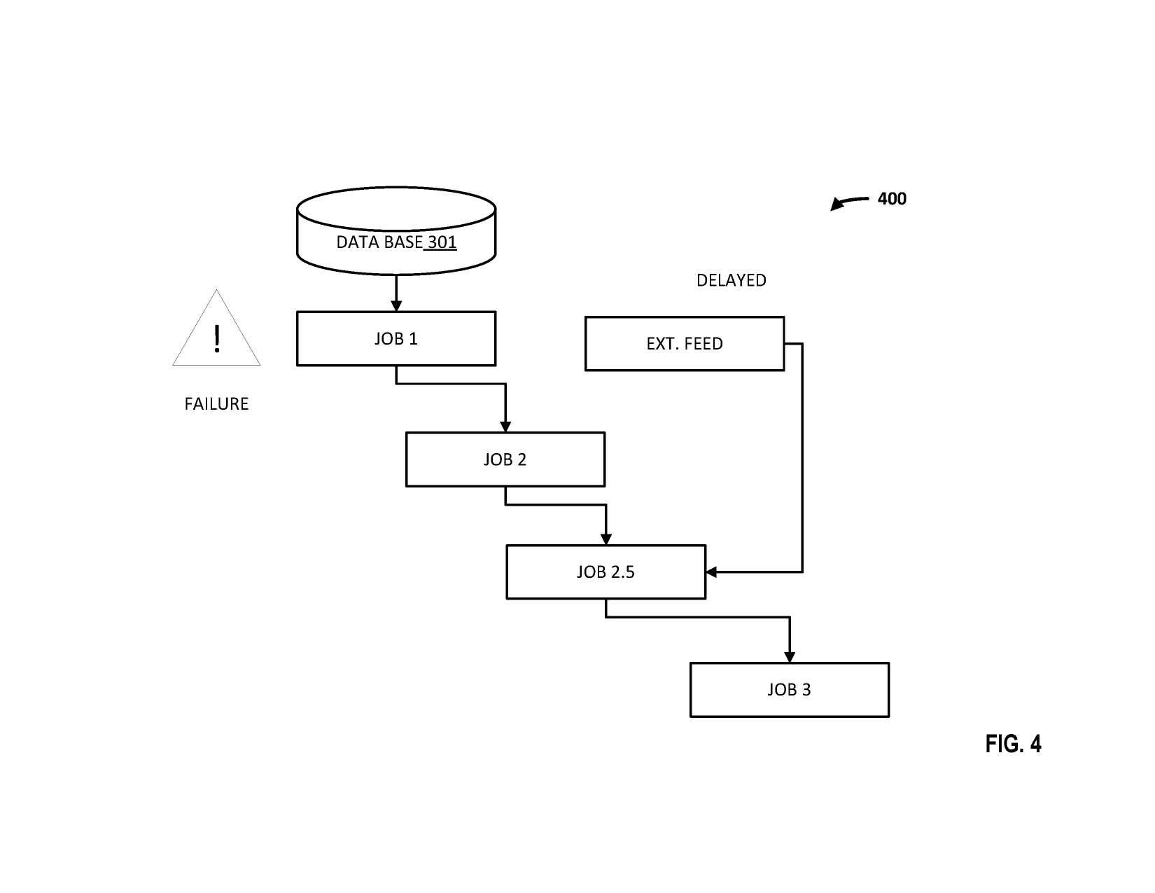

FIGS. 3-4 illustrate non-limiting use cases of intelligent job scheduling in accordance with one or more embodiments described herein.

FIG. 3 illustrates a use case 300 of additional jobs being added to an existing schedule. As shown, Job 2.5 has been added to an existing job schedule being executed on database 301and should be executed between Jobs 2 and 3 due to dependencies and scheduling constraints. Accordingly, flow path component 110 can generate all possible flow paths that allow the existing schedule to be updated to include Job 2.5 within the allotted scheduling constraints and dependencies. Recommendation component 204 can recommend one or more of the possible job flow paths that add Job 2.5, and selection component 208 can then select one of the recommended job flow paths and execute the selected job flow path.

FIG. 4 illustrates a dynamic flow use case 400 in accordance with one or more embodiments described herein. Within job processing execution failure or errors can occur. As shown, Job 1 has failed to execute properly, thereby delaying all jobs further down the schedule. When a job failure or delay occurs, flow path component 110 can generate new possible flow paths taking the failure into account. These new flow paths can comprise changing what hardware specific jobs will execute on or updating execution times of the jobs. These new possible flow paths can be optimized or recommended based on mitigating the delays or execution cost increases associated with the execution failure of Job 1. Accordingly, the system and method described herein enable a minimization of downstream impacts of the execution failure or delay of jobs within an existing schedule.

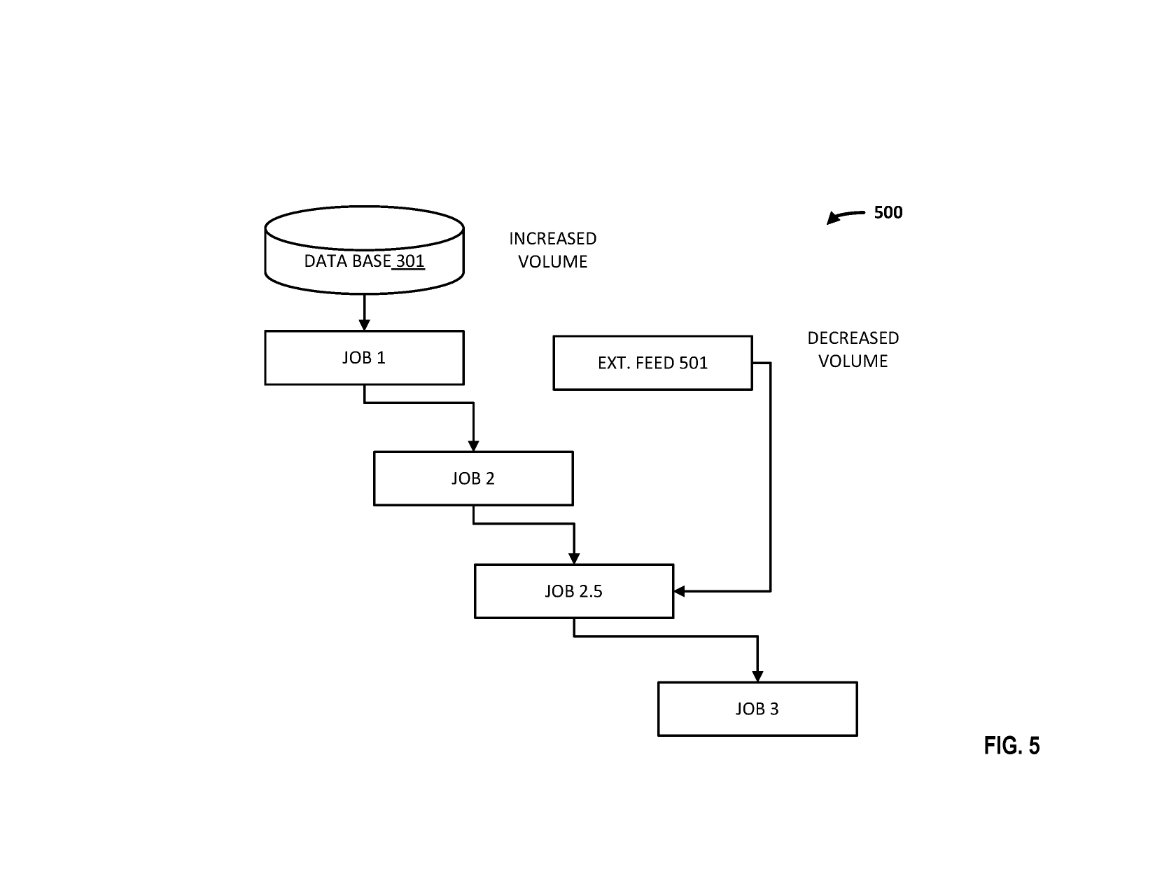

FIG. 5 illustrates a changing data pattern use case 500 in accordance with one or more embodiments described herein.

For jobs that are executed often or repeatedly, set schedules are often utilized to continuously or repeatedly execute these jobs. However, the underlying data of these jobs may slowly change overtime, meaning that even schedules that were once optimized may lose performance over time as underlying data (e.g., inputs, code, storage location, hardware configurations, etc.) changes. These changes can be slow and subtle, making it difficult for entities to identify when performance losses have occurred. For example, as shown database 301 has increased in usage volume over time and extension feed 501 has decreased in usage volume over time. As collection component 104 collects historical runtime data for job schedules, collection component 104 can identify when changing data patterns have caused performance losses and then instruct flow path component 110 to generate new possible flow paths. This allows for an easy and automatic updating of previously optimized job schedules that may no longer be well optimized.

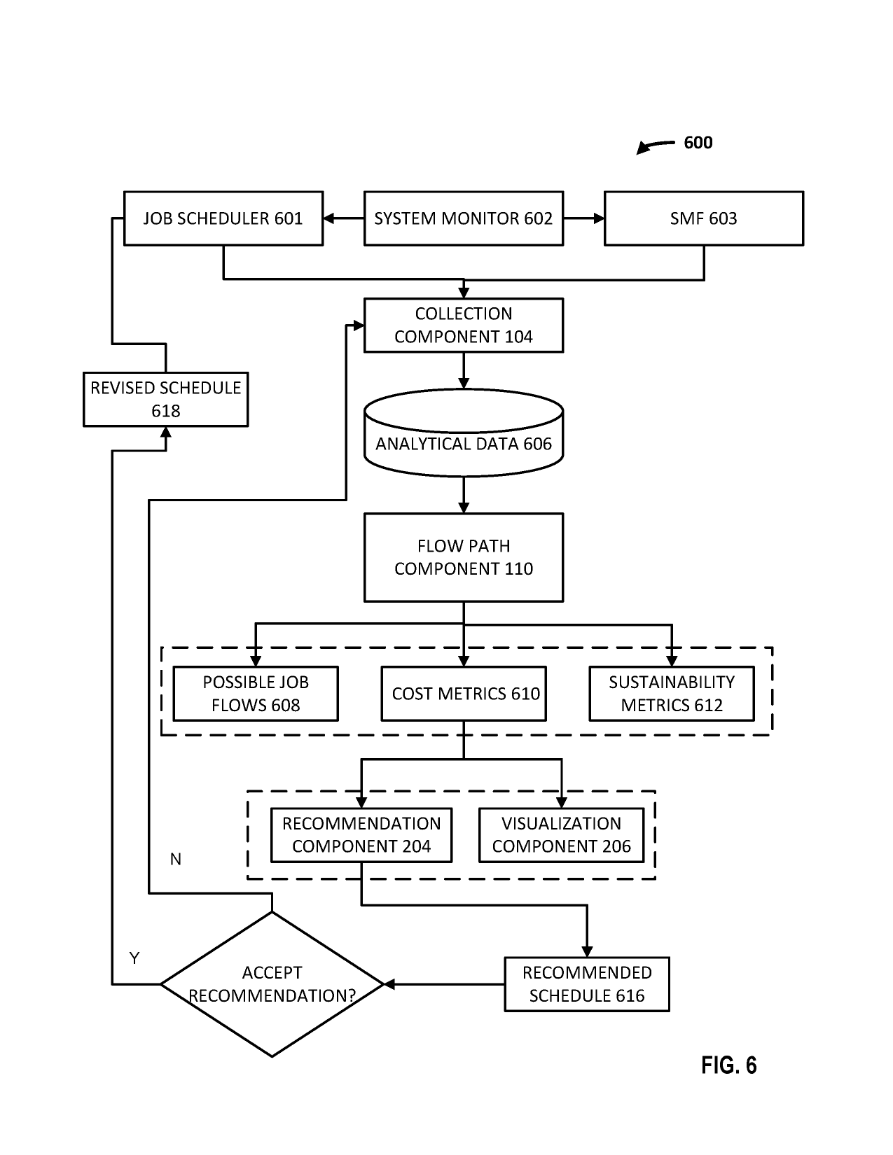

FIG. 6 illustrates a flow diagram of intelligent batch processing in accordance with one or more embodiments described herein. As shown, collection component 104 can collect historical data, live status data, and a job queue from job scheduler 601 and systems management facility 603. This collected analytical data 606 is then passed to flow path component 110 which uses analytical data 606 to generate possible job flows 608, cost metrics 610 for the possible job flows, and sustainability metrics 612 related to the job flows. The possible job flows 608, the cost metrics 610 and the sustainability metrics 612 can be passed to both recommendation component 204 and visualization component 206. Visualization component 206 can generate graphical representations of the possible job flows 608 along with the associated cost metrics 610 and sustainability metrics 612. Recommendation component 204 can then generate one or more recommended schedules 616 of job flows from possible job flows 608. If the recommendation is accepted, the revised schedule 618 is sent to job scheduler 601 and executed. If the recommendation is not accepted, the rejected recommendation and any accompanying feedback can be collected by collection component 104 and used to retrain, finetune or update flow path component 110 and/or recommendation component 204.

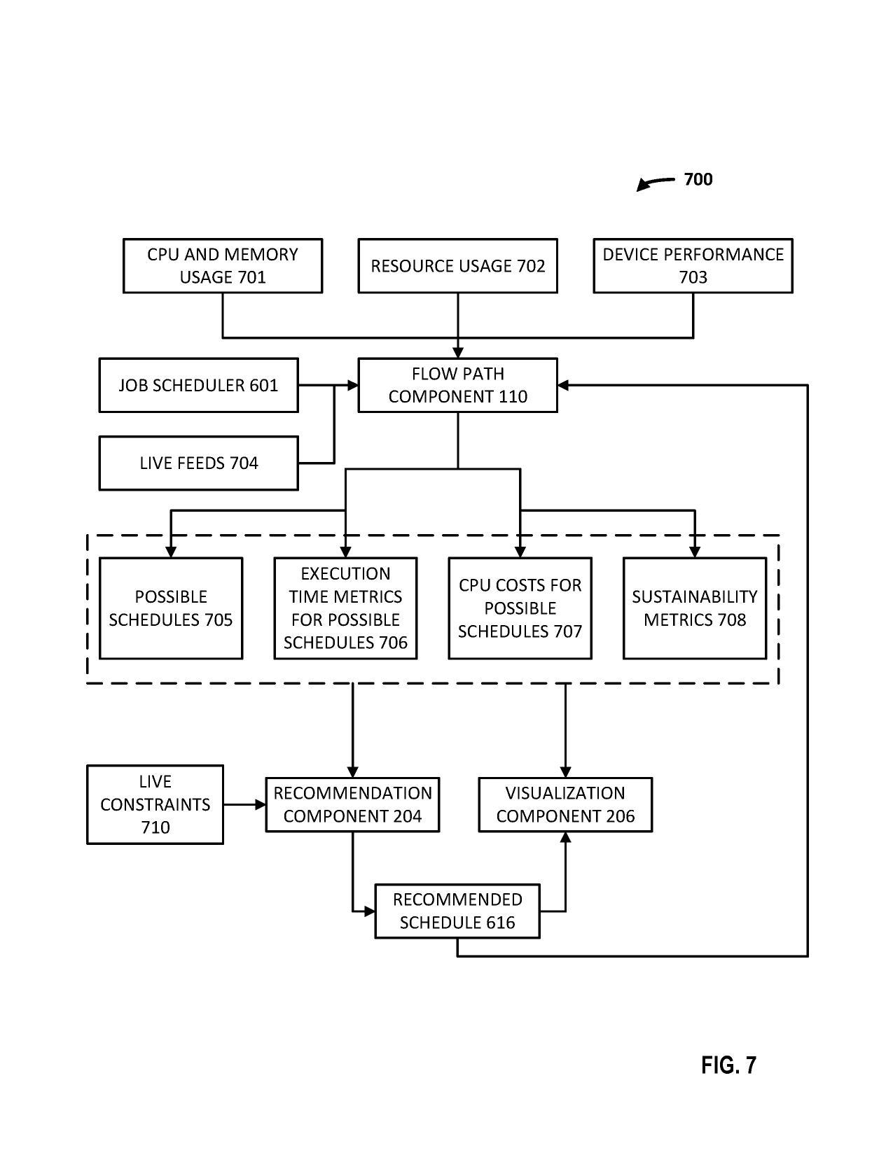

FIG. 7 illustrates an alternative flow diagram of intelligent batch processing in accordance with one or more embodiments described herein. As shown, CPU and memory usage data 701, resource usage data 702 and device performance data 703 can be fed to flow path component 110 as input. In one or more embodiments, CPU and memory usage data 701 can comprise SMF (system management facility) type 30, 70 and 72 logs from a systems management facility, resource usage data 702 can comprise SMF type 89 and 110 logs from the systems management facility, and device performance data 703 can comprise SMF type 14, 15 and 74 logs the systems management facility. Using these inputs, along with a job queue from job scheduler 601 and live feed 704 detailing the progress on currently executing jobs, flow path component 110 can generate outputs comprising possible schedules/flow paths 705, execution time metrics for the possible schedules 706, CPU costs for possible schedules 707 and sustainability metrics 708. Visualization component 206 can use these outputs to generate graphical representation of the possible schedules 705. Recommendation component 204 can then generate recommended schedule 616 based on the outputs and live resource constrains 710 and whether the recommended schedule 616 is accepted or rejected can be used to retrain or finetune flow path component 110. It should be appreciated that the log types described above are merely examples, and usage of other log types is envisioned.

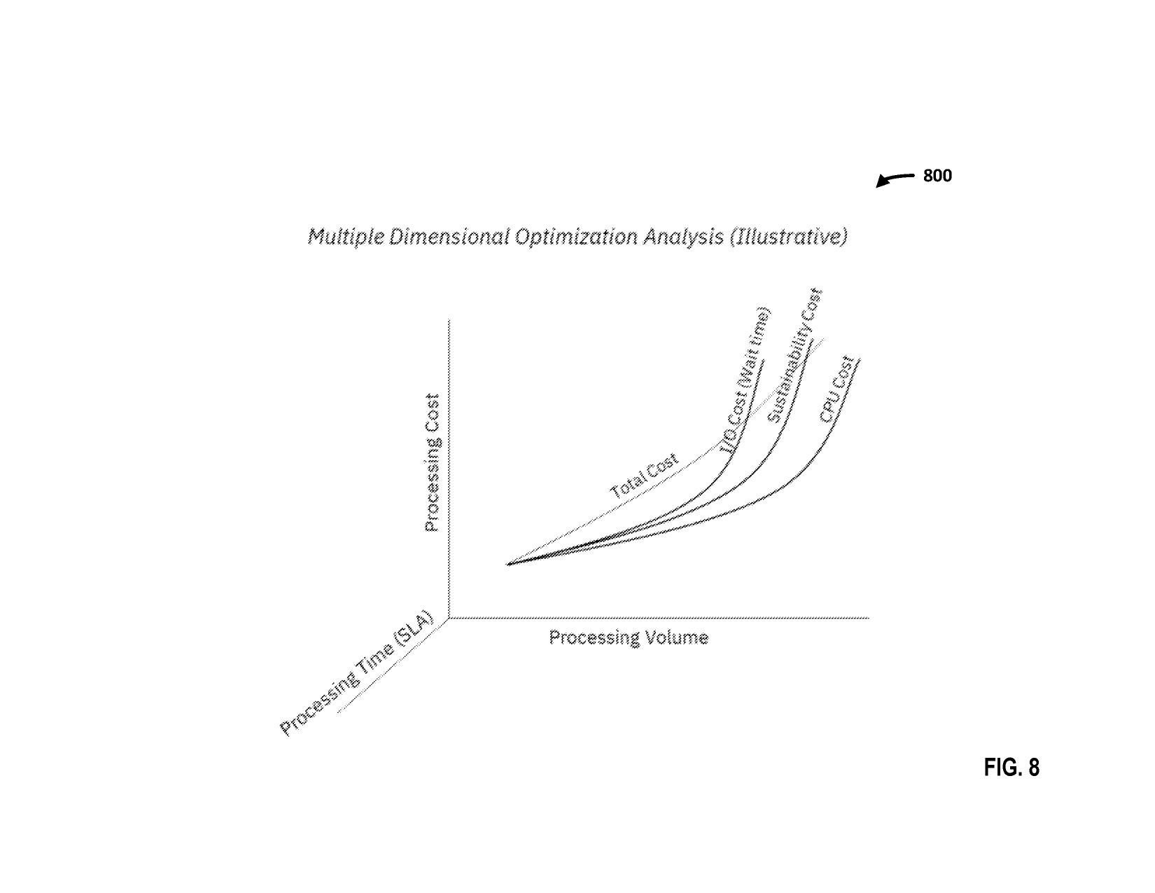

FIG. 8 illustrates a graph 800 showing factors that are weighed as part of a recommendation process in accordance with one or more embodiments described herein. As shown, recommendation component 204 can consider factors such as CPU cost, sustainability metrics, and job wait times as part of a total cost calculation that can be utilized to recommend job flow paths.

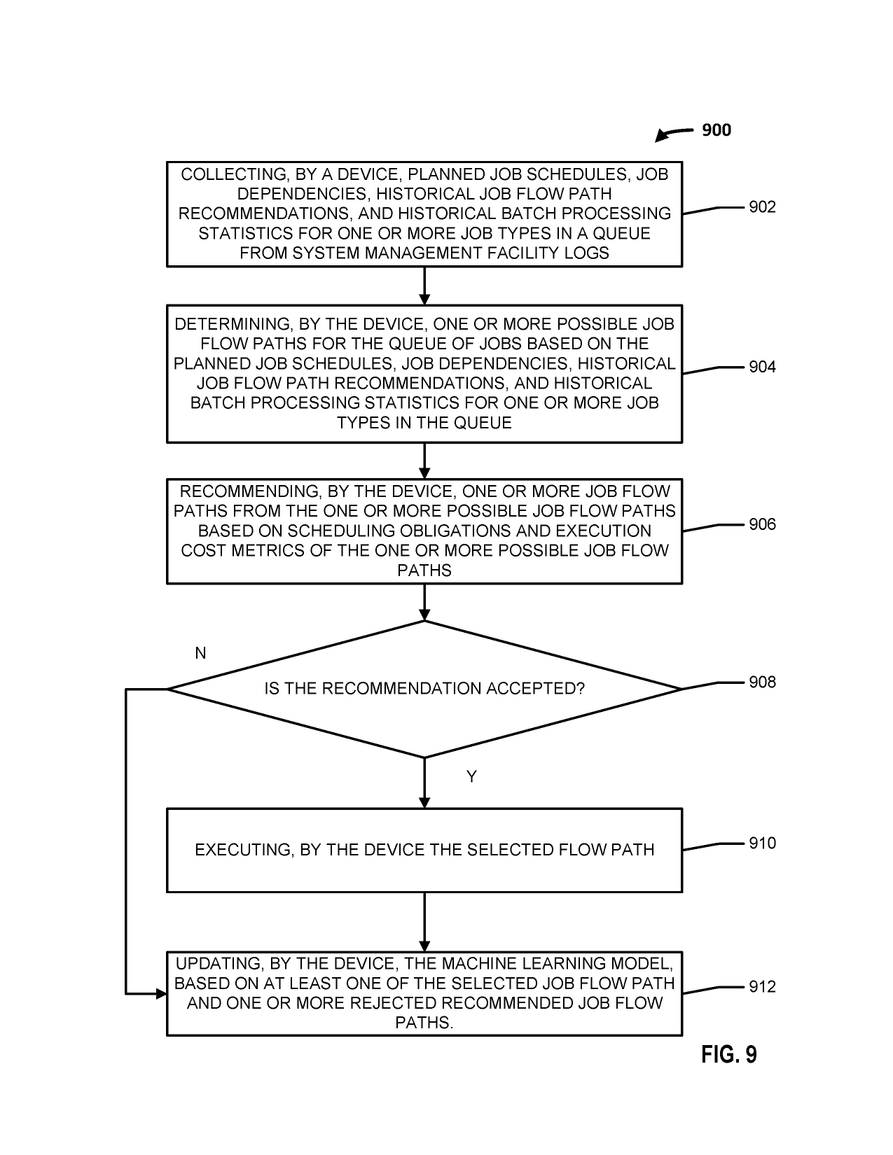

FIG. 9 illustrates a flow diagram of an example, non-limiting, computer-implemented method 900 that facilitates intelligent batch processing in accordance with one or more embodiments described herein.

At 902, method 900 can comprise collecting, by a device (e.g., system 102 and/or collection component 104), operatively coupled to a processor (e.g., processor 106), planned job schedules, job dependencies, historical job flow path recommendations, and historical batch processing statistics for one or more job types in a queue from system management facility logs.

At 904, method 900 can comprise determining, by the device (e.g., system 102 and/or optimization component 216), one or more possible job flow paths for the queue of jobs based on the planned job schedules, job dependencies, historical job flow path recommendations, and historical batch processing statistics for one or more job types in the queue. For example, as described above in relation to FIGS. 1-2 and 6-7, flow path component 110 can utilize the collected data to generate all possible job flow paths that execute the queue of jobs.

At 906, method 900 can comprise recommending, by the device (e.g., system 102 and/or recommendation component 204), one or more job flow paths from the one or more possible job flow paths based on scheduling obligations and execution cost metrics of the one or more possible job flow paths. For example, as described above in relation to FIGS. 1-2 and 6-7, recommendation component 204 can rank the possible job flow paths based on execution costs such as hardware costs, data transfer costs, energy consumption and/or sustainability costs. The one or more possible job flow paths can be further ranked based on scheduling constraints, wherein job flow paths that promise the execution of specific jobs by specific deadlines are prioritized.

At 908, method 900 can comprise determining, by the device (e.g., system 102 and/or selection component 208), if a recommendation is accepted or rejected. For example, a recommended job flow path can be accepted or rejected automatically by selection component 208, or a recommendation can be accepted or rejected based on input from an entity, such as a user. In response to a “YES” determination, method 900 can proceed to step 910 and execute the recommended job flow path. In response to a “NO” determination, method 900 can proceed to step 912.

At 912, method 900 can comprise updating, by the device, the machine learning model, based on at least one of the selected job flow path and one or more rejected recommend job flow paths. For example, as described above in relation to FIGS. 1-2 and 6-7, update component 210 can update the machine learning model or models of flow path component 110 and/or collection component 104. For example, a reward/penalty score can be applied based on whether the recommendation was accepted or rejected. In another example, the accepted and/or rejected recommendations can be added to knowledge source database for the machine learning models.

A practical application of system 102 is the ability to reduce the workload of hardware components when executing a job queue. For example, by recommending job flow paths that minimize execution costs, such as CPU workloads, the workloads of hardware components, such a CPUS and memory units can be minimized, thus reducing the overall workload of the system. Furthermore, by basing the possible job flow paths on real-time resource availability, the execution costs can be spread across a wider array of hardware components, thus better spreading the workload across the hardware components.

It is to be appreciated that systems 102 and 202 can utilize various combination of electrical components, mechanical components, and circuitry that cannot be replicated in the mind of a human or performed by a human as the various operations that can be executed by systems 102, 202 and/or components thereof as described herein are operations that are greater than the capability of a human mind. For instance, the amount of data processed, the speed of processing such data, or the types of data processed by systems 102 and 202 over a certain period of time can be greater, faster, or different than the amount, speed, or data type that can be processed by a human mind over the same period of time. According to several embodiments, systems 102 and 202 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that systems 102 and 202 can include information that is impossible to obtain manually by an entity, such as a human user. For example, the type, amount, and/or variety of information included in systems 102 and 202 can be more complex than information obtained manually by an entity, such as a human user.

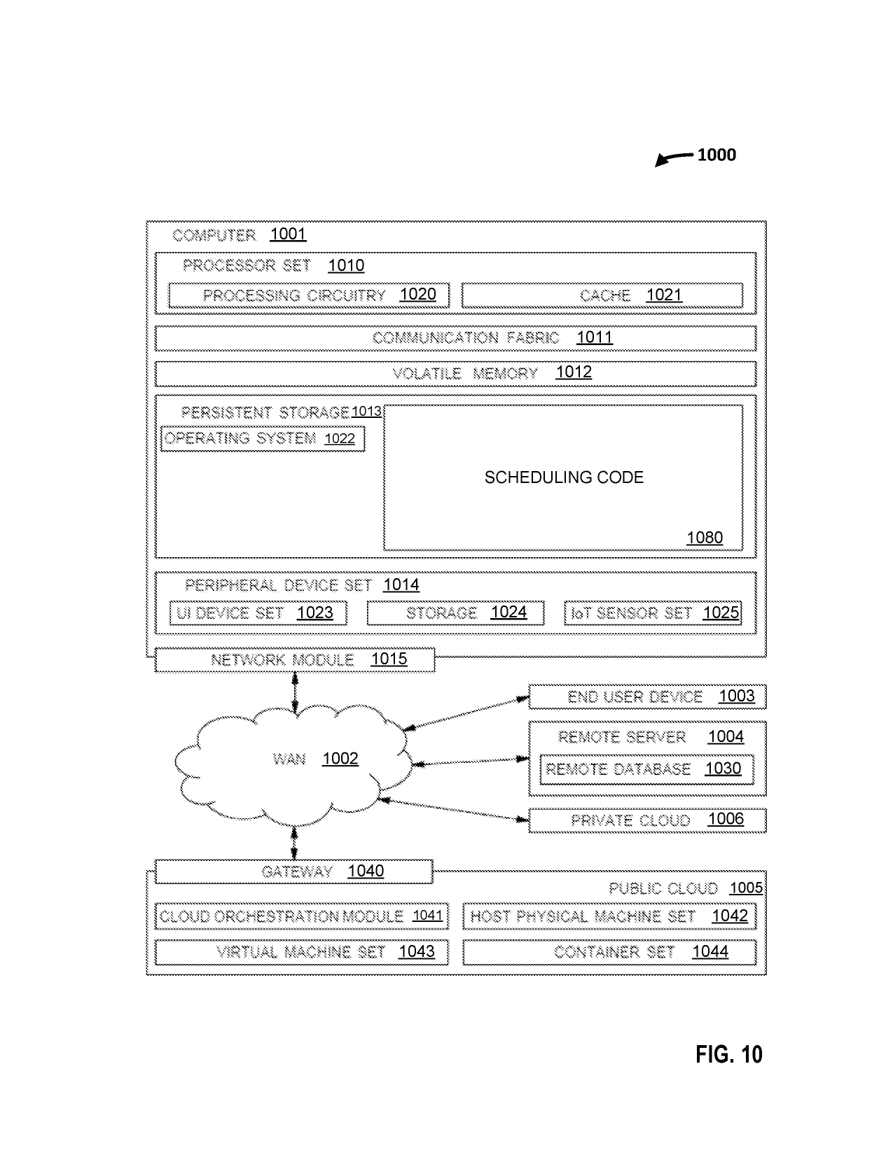

FIG. 10 and the following discussion are intended to provide a brief, general description of a suitable computing environment 1000 in which one or more embodiments described herein at FIGS. 1-9 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as translation of an original source code based on a configuration of a target system by the scheduling code 1080. In addition to block 1080, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1080, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method can be distributed among multiple computers and/or between multiple locations. On the other hand, in this presentation of computing environment 1000, detailed discussion is focused on a single computer, specifically computer 1001, to keep the presentation as simple as possible. Computer 1001 can be located in a cloud, even though it is not shown in a cloud in FIG. 10. On the other hand, computer 1001 is not required to be in a cloud except to any extent as can be affirmatively indicated.

PROCESSOR SET 1010 includes one, or more, computer processors of any type now known or to be developed in the future. Processing circuitry 1020 can be distributed over multiple packages, for example, multiple, coordinated integrated circuit chips. Processing circuitry 1020 can implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set can be located “off chip.” In some computing environments, processor set 1010 can be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods can be stored in block 1080 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input / output ports and the like. Other types of signal communication paths can be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory can be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 can be a read only memory (ROM), but typically at least a portion of the persistent storage allows writing of data, deletion of data and re-writing of data. Some familiar forms of persistent storage include magnetic disks and solid-state storage devices. Operating system 1022 can take several forms, such as various known proprietary operating systems or open-source Portable Operating System Interface type operating systems that employ a kernel. The code included in block 1080 typically includes at least some of the computer code involved in performing the inventive methods.

PERIPHERAL DEVICE SET 1014 includes the set of peripheral devices of computer 1001. Data communication connections between the peripheral devices and the other components of computer 1001 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 can include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 can be persistent and/or volatile. In some embodiments, storage 1024 can take the form of a quantum computing storage device for storing data in the form of qubits. In embodiments where computer 1001 is required to have a large amount of storage (for example, where computer 1001 locally stores and manages a large database) then this storage can be provided by peripheral storage devices designed for storing large amounts of data, such as a storage area network (SAN) that is shared by multiple, geographically distributed computers. IoT sensor set 1025 is made up of sensors that can be used in Internet of Things applications. For example, one sensor can be a thermometer and another sensor can be a motion detector.

NETWORK MODULE 1015 is the collection of computer software, hardware, and firmware that allows computer 1001 to communicate with other computers through WAN 1002. Network module 1015 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001) and can take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 can be a client device, such as thin client, heavy client, mainframe computer and/or desktop computer.

REMOTE SERVER 1004 is any computer system that serves at least some data and/or functionality to computer 1001. Remote server 1004 can be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data can be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs can be stored as images and can be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware and firmware allowing public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the "C" programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer-implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system comprising:
a memory that stores computer executable components; and
a processor that executes the computer executable components stored in the memory, wherein the computer executable components comprise:
a collection component that collects planned job schedules, job dependencies, historical job flow path recommendations, and historical batch processing statistics for one or more job types in a queue from system management facility logs; and
a flow path component that determines, using a machine learning model, one or more possible job flow paths for the queue of jobs based on the planned job schedules, the job dependencies, the historical job flow path recommendations, and the historical batch processing statistics for the one or more job types in the queue.

2. The system of claim 1, wherein the computer executable components further comprise a recommendation component that recommends one or more job flow paths from the one or more possible job flow paths based on scheduling obligations and execution cost metrics of the one or more possible job flow paths.

3. The system of claim 1, wherein the computer executable components further comprise a visualization component that generates a graphical representation of the one or more possible job flow paths and one or more execution cost metrics of the one or more possible job flow paths.

4. The system of claim 2, wherein the computer executable components further comprise a selection component that selects a job flow path from the one or more recommended job flow paths and executes the selected job flow path.

5. The system of claim 4, wherein the computer executable components further comprise an update component that updates the machine learning model, based on at least one of the selected job flow path and one or more rejected recommended job flow paths.

6. The system of claim 1, wherein the historical batch processing statistics comprise processing volume, CPU time, and elapsed time from system management records.

7. The system of claim 2, wherein the recommendation component recommends one or more job flow paths from the one or more possible job flow paths further based on sustainability metrics, wherein the sustainability metrics comprise, type of electrical generation source for an execution environment and availability of electrical power from specific sources at one or more times.

8. A computer-implemented method comprising:
collecting, by a device operatively coupled to a processor, planned job schedules, job dependencies, historical job flow path recommendations, and historical batch processing statistics for one or more job types in a queue from system management facility logs; and
generating, by the device, using a machine learning model, one or more possible job flow paths for the queue of jobs based on the planned job schedules, the job dependencies, the historical job flow path recommendations, and the historical batch processing statistics for the one or more job types in the queue.

9. The computer-implemented method of claim 8, further comprising recommending, by the device, one or more job flow paths from the one or more possible job flow paths based on scheduling obligations and execution cost metrics of the one or more possible job flow paths.

10. The computer-implemented method of claim 8, further comprising generating, by the device, a graphical representation of the one or more possible job flow paths and one or more execution cost metrics of the one or more possible job flow paths.

11. The computer-implemented method of claim 9, further comprising selecting, by the device, a job flow path from the one or more recommended job flow paths;
and executing, by the device the selected job flow path.

12. The computer-implemented method of claim 11, further comprising, updating, by the device, the machine learning model, based on at least one of the selected job flow path and one or more rejected recommended job flow paths.

13. The computer- implemented method of claim 9, wherein the recommending is further based on sustainability metrics, wherein the sustainability metrics comprise, type of electrical generation source for an execution environment and availability of electrical power from specific sources at one or more times.

14. A computer program product comprising a non-transitory computer-readable memory having program instructions embodied therewith, the program instructions executable by a processor to cause the processor to:
collect, by the processor, planned job schedules, job dependencies, historical job flow path recommendations, and historical batch processing statistics for one or more job types in a queue from system management facility logs; and
generating, by the processor, using a machine learning model, one or more possible job flow paths for the queue of jobs based on the planned job schedules, the job dependencies, the historical job flow path recommendations, and the historical batch processing statistics for the one or more job types in the queue.

15. The computer program product of claim 14, wherein the program instructions are further executable by the processor to cause the processor to:
recommend, by the processor, one or more job flow paths from the one or more possible job flow paths based on scheduling obligations and execution cost metrics of the one or more possible job flow paths.

16. The computer program product of claim 14, wherein the program instructions are further executable by the processor to cause the processor to:
generate, by the processor, a graphical representation of the one or more possible job flow paths and one or more execution cost metrics of the one or more possible job flow paths.

17. The computer program product of claim 15, wherein the program instructions are further executable by the processor to cause the processor to:
select, by the processor, a job flow path from the one or more recommended job flow paths and;
execute, by the processor, the selected job flow path.

18. The computer program product of claim 17, wherein the program instructions are further executable by the processor to cause the processor to:
update, by the processor, the machine learning model, based on at least one of the selected job flow path and one or more rejected recommended job flow paths.

19. The computer program product of claim 14, wherein the historical batch processing statistics comprise processing volume, CPU time, and elapsed time from system management records.

20. The computer program product of claim 15, wherein the recommending is further based on sustainability metrics, wherein the sustainability metrics comprise, type of electrical generation source for an execution environment and availability of electrical power from specific sources at one or more times.
